(19) United States
(12) Patent Application Publication
(10) Pub. No.: US 2026/0291626 A1
(43) Pub. Date: Sep. 24, 2026

(54) AUTOMATIC ALIGNMENT SCHEME FOR ORBITAL ANGULAR MOMENTUM RECEIVER

(71) Applicant: LENOVO (BEIJING) LIMITED, Beijing (CN)

(72) Inventors: Chenxi ZHU, Fairfax, VA (US); Bingchao LIU, Beijing (CN); Yi ZHANG, Beijing (CN)

(21) Appl. No.: 19/472,527

(22) PCT Filed: Apr. 14, 2023
(86) PCT No.: PCT/CN2023/088366

§ 371 Date: Oct. 3, 2025

(51) Int. Cl. H04B 17/21

(52) U.S. Cl. CPC H04B 17/221

(57) ABSTRACT

Methods and apparatuses for automatic alignment scheme for orbital angular momentum receiver are disclosed. In one embodiment, an apparatus includes a receiver, wherein, the receiver includes N pairs of OAM RX antennas, each pair of OAM RX antennas are placed on opposite sides with an equal radius from the centre of the receiver in a different angle, where N is or more, the apparatus comprises a processor, wherein, the processor is configured to receive, via the N pairs of OAM RX antennas, a calibration signal sent using a single OAM mode; and estimate misalignment of the receiver according to the received calibration signal.

### FIELD

The subject matter disclosed herein generally relates to wireless communications, and more particularly relates to methods and apparatuses for automatic alignment scheme for orbital angular momentum (OAM) receiver.

### BACKGROUND

OAM is a candidate technology for 6G. OAM uses different electromagnetic wave propagation modes to transmit multiple streams of data in a line of sight environment.

OAM transmission relies on specially designed Transmitter (TX) antennas and Receiver (RX) antennas to generate and receive specific OAM modes. It is very important that the TX antennas and the RX antennas are well aligned with each other. Otherwise, the received modes will degenerate and the receiving quality will degrade significantly.

This invention targets for automatic alignment scheme for OAM receiver.

### BRIEF SUMMARY

Methods and apparatuses for automatic alignment scheme for OAM receiver and transmitter are disclosed.

In one embodiment, an apparatus includes a receiver, wherein, the receiver includes N pairs of OAM RX antennas, each pair of OAM RX antennas are placed on opposite sides with an equal radius from the centre of the receiver in a different angle, where N is 2 or more, the apparatus comprises a processor, wherein, the processor is configured to receive, via the N pairs of OAM RX antennas, a calibration signal sent using a single OAM mode; and estimate misalignment of the receiver according to the received calibration signal.

In some embodiment, all N pairs of OAM RX antennas are placed with an equal radius from the centre of the receiver. Preferably, all N pairs of OAM RX antennas are evenly placed.

In some embodiment, the misalignment of the receiver is corrected by a servo system.

In some embodiment, the N pairs of OAM RX antennas form a uniform concentric array.

In some embodiment, the processor is further configured to receive, via the N pairs of OAM RX antennas, a signal indicating the calibration signal. In particular, the signal is a RRC signaling, or a MAC CE, or a DCI.

In some embodiment, the calibration signal is a dedicated reference signal or a data-carrying signal.

In some embodiment, the single OAM mode (l, p) has parameters p=0 and l≠0.

In another embodiment, a method performed at an apparatus including a receiver where the receiver includes N pairs of OAM RX antennas, each pair of OAM RX antennas are placed on opposite sides with an equal radius from the centre of the receiver in a different angle, where N is 2 or more, the method comprises: receiving, via the N pairs of OAM RX antennas, a calibration signal sent using a single OAM mode; and estimating misalignment of the receiver according to the received calibration signal.

In still another embodiment, an apparatus may include a transmitter, wherein, the transmitter includes OAM TX antennas, the apparatus comprising a processor, wherein the processor is configured to transmit, via the OAM TX antennas, a calibration signal using a single OAM mode.

In yet another embodiment, a method performed at an apparatus including a transmitter, where the transmitter includes OAM TX antennas, the method comprises: transmitting, via the OAM RX antennas, a calibration signal using a single OAM mode.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates OAM transmission with perfectly aligned transmitter and receiver;

FIG. 2(a) illustrates a view from the front in x-y plane;

FIG. 2(b) illustrates a view from the front in x′-y′ plane;

FIG. 2(c) illustrates a view from the side in y′-z plane;

FIG. 3(a) illustrates two pairs of RX antennas located at 0°, 90°, 180°, 270° at the rim of the receiver;

FIG. 3(b) illustrates 2N pairs of antennas located at the rim of the receiver;

FIG. 4(a) illustrates two groups of 4 antennas with the same radius;

FIG. 4(b) illustrates two groups of 4 antennas with different radii, in which each group has the same radius;

FIG. 5 illustrates an example of uniform concentric array (UCA) type RX antennas;

FIG. 6 is a schematic flow chart diagram illustrating an embodiment of a method;

FIG. 7 is a schematic flow chart diagram illustrating an embodiment of a method; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In OAM Multiple-Input Multiple-Output (MIMO), different data streams are carried by different OAM modes. Each mode is characterized by (l, p) (i.e., a combination of/and p), where l is an integer (e.g., negative integer, 0 and positive integer) and p is non-negative integer (e.g., 0 and positive integer). In theory, these OAM modes remain orthogonal as they travel through the free space.

However, the receiver can receive these different OAM modes orthogonally only if the receiver is perfectly aligned with the transmitter. When the receiver is misaligned with the transmitter, e.g., is tilted, different OAM modes are no longer orthogonal, and accordingly, cross-modes interference (which may be referred to as cross interference) occurs. Incidentally, the cross interference among different beams for traditional MIMO receiver does not occur even if the receiving antenna is misaligned, because the cross interference in the traditional MIMO, which is part of the multipath channel, can be absorbed naturally.

Under the paraxial approximation, the electromagnetic (EM) field of OAM mode (l, p) is described by the Laguerre-Gaussian modes in the following Equation (1):

$$u ( l , p , r , ϕ , z , t ) = {E}_{l , p} u ( l , p , r , z ) exp ( - il ϕ ) exp ( i ω t ) = {C}_{lp}^{LG} \frac{{w}_{0}}{w ( z )} {( \frac{\sqrt{2} r}{w ( z )} )}^{\vert l \vert} exp ( - \frac{{r}^{2}}{{w}^{2} ( z )} ) {L}_{p}^{\vert l \vert} ( \frac{2 {r}^{2}}{{w}^{2} ( z )} ) exp ( - \frac{{ikw}_{0}^{2} {r}^{2} z}{2 {z}_{R}^{2} {w}^{2} ( z )} ) exp ( - il ϕ ) exp ( i ( 2 p + \vert l \vert + 1 ) {tan}^{- 1} ( \frac{z}{{z}_{R}} ) ) exp ( - ikz ) exp ( i ω t ) \qquad Equation ( 1 )$$

where, E_{l,p} is the initial amplitude of the electric field of mode (l, p),

$${L}_{p}^{\vert l \vert} ( x )$$

is a generalized Laguerre polynomial,

$${C}_{l , p}^{LG} = \sqrt{\frac{2 p !}{π ( p + \vert l \vert ) !}}$$

is the normalization factor (for nominal power),

$$w ( z ) = {w}_{0} \sqrt{1 + \frac{{z}^{2}}{{z}_{R}^{2}}}$$

is the radius of the beam at z, w₀ is the size of the beam waist,

$${z}_{R} = \frac{π {w}_{0}^{2} n}{λ}$$

is the Kayleigh range,

$$R ( z ) = z ( 1 + {( \frac{{z}_{R}}{z} )}^{2} )$$

is the radius of curvature at z, 1/R(z) is the curvature,

$$k = \frac{2 π}{λ}$$

is the wavevector,

r, φ, z are three ordinates in column coordinate, and ω is angular speed, t is time.

The simplest form of Laguerre polynomial is for p=0,

$${L}_{0}^{l} ( x ) = 1.$$

So, of p=0, Equation (1) can be simplified as Equation (2) as follows:

$$u ( l , 0 , r , ϕ , z , t ) = {C}_{l , 0}^{L G} \frac{{w}_{0}}{w ( z )} {( \frac{\sqrt{2} r}{w ( z )} )}^{\vert l \vert} exp ( - \frac{{r}^{2}}{{w}^{2} ( z )} ) exp ( - \frac{{ikw}_{0}^{2} {r}^{2} z}{2 {z}_{R}^{2} {w}^{2} ( z )} ) exp ( - il ϕ ) exp ( i ( \vert l \vert + 1 ) {tan}^{- 1} ( \frac{z}{{z}_{R}} ) ) exp ( - ikz ) exp ( i ω t ) \qquad Equation ( 2 )$$

Considering

$$\frac{r}{w ( z )} = \frac{r}{{w}_{0} \sqrt{1 + \frac{{z}^{2}}{{z}_{R}^{2}}}} ,$$

and r′=r·r_{Δ}, z′=z+Δz, and Δ′=φ+ΔΔ, the first order approximation is used,

$$\frac{{r}^{′}}{w ( {z}^{′} )} = \frac{{r}^{′}}{{w}_{0} \sqrt{1 + \frac{{( z + Δ z )}^{2}}{{z}_{R}^{2}}}} ≅ \frac{r}{w ( z )} {r}_{Δ} ( 1 - \frac{z Δ z}{{z}_{R}^{2} + {z}^{2}} ) .$$

Accordingly,

$$u ( l , 0 , {r}^{′} , {ϕ}^{′} , {z}^{′} , t ) = {C}_{l 0}^{LG} \frac{{w}_{0}}{w ( z )} {( \frac{\sqrt{2} r}{w ( z )} )}^{\vert 1 \vert} exp ( - \frac{{r}^{2}}{{w}^{2} ( z )} ) exp ( - \frac{{ikw}_{0}^{2} {r}^{2} z}{2 {z}_{R}^{2} {w}^{2} ( z )} ) exp ( - il {ϕ}^{′} ) exp ( i ( \vert l \vert + 1 ) {tan}^{- 1} ( \frac{z}{{z}_{R}} ) ) ( 1 - \frac{z Δ z}{{z}_{R}^{2} + {z}^{2}} ) {r}_{Δ}^{\vert l \vert} ( 1 - \frac{\vert l \vert z Δ z}{{z}_{R}^{2} + {z}^{2}} ) ( 1 + \frac{{r}^{2}}{{w}^{2} ( z )} \frac{2 z Δ z}{{z}_{R}^{2} + {z}^{2}} ) exp ( \frac{- ik}{2} \frac{{w}_{0}^{2} {r}^{2}}{{z}_{R}^{2} {w}^{2} ( z )} \frac{( {z}_{R}^{2} - {z}^{2} )}{( {z}_{R}^{2} + {z}^{2} )} Δ z ) exp ( i ( \vert l \vert + 1 ) \frac{{z}_{R} Δ z}{( {z}_{R}^{2} + {z}^{2} )} ) exp ( - {ikz}^{′} ) exp ( i ω t ) ≅ u ( l , 0 , r , ϕ , z , t ) {r}_{Δ}^{\vert l \vert} ( 1 - \frac{z Δ z}{{z}_{R}^{2} + {z}^{2}} - \frac{\vert l \vert z Δ z}{{z}_{R}^{2} + {z}^{2}} + \frac{{r}^{2}}{{w}^{2} ( z )} \frac{2 z Δ z}{{z}_{R}^{2} + {z}^{2}} ) exp ( - i ( \frac{{kw}_{0}^{2} {r}^{2}}{2 {z}_{R}^{2} {w}^{2} ( z )} \frac{( {z}_{R}^{2} - {z}^{2} )}{( {z}_{R}^{2} + {z}^{2} )} - ( \vert l \vert + 1 ) \frac{{z}_{R} Δ z}{( {z}_{R}^{2} + {z}^{2} )} ) + k ) Δ z ) exp ( - il Δϕ )$$

At far field, z»Δz, zz»z_{R}.

So,

$$u ( l , 0 , {r}^{′} , {ϕ}^{′} , {z}^{′} , t ) ≅ u ( l , 0 , r , ϕ , z , t ) {r}_{Δ}^{\vert l \vert} exp ( - il Δϕ ) exp ( - ik Δ z )$$

FIG. 1 illustrates OAM transmission with perfectly aligned transmitter and receiver.

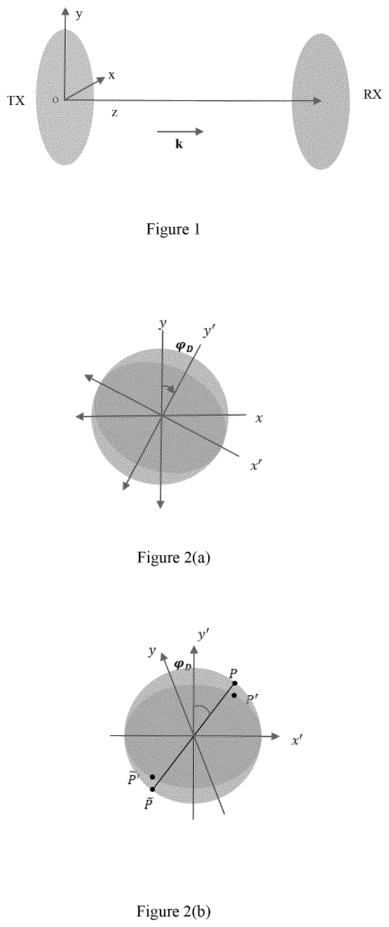

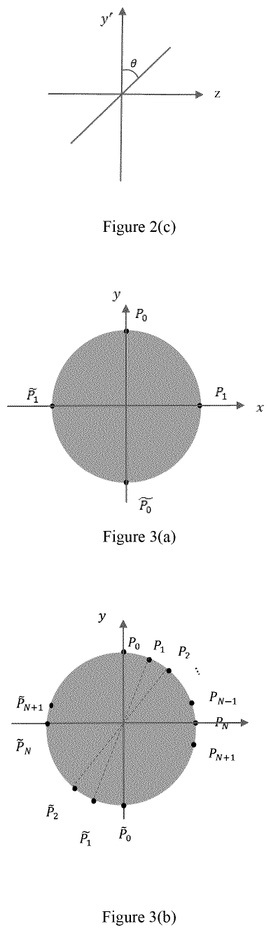

If the receiver is misaligned, e.g., tilted, with the transmitter, its tilt can be represented by a pair of tilt angles (φ_{D}, θ) as viewed from the front and the side as shown in FIGS. 2(a), 2(b) and 2(c). FIG. 2(a) illustrates a view from the front in x-y plane (where the x-y plane corresponds to r, φ, that is, x=rcos (Ε) and y=rsins (φ)), in which a first tilt angle φ_{D} is shown as the relative angle between y and y′. It means that the first tilt angle φ_{D} represents the tilt angle in x-y plane. If the x-y plane is represented as x′-y′ plane, FIG. 2(a) becomes FIG. 2(b), which illustrates a view from the front in the x′-y′ plane (corresponding to x-y plane). FIG. 2(c) illustrates a view from the side in y′-z plane, in which the second tilt angle θ is shown as a relative angle between y′ and z. It means that the second tilt angle θ represents the tilt angle in y′-z plane.

FIG. 2(b) also illustrates a pair of points (P, \tilde{P}) that are diagonal to each other on the receiver. If the receiver is tilted by a pair of tilt angles (φ_{D}, θ), the pair of points will become (P′,\tilde{P}′).

In the cylindrical coordinate system defined by r′-φ′-z that corresponds to x′-y′-z (i.e., x=r′cos (φ′) and y=r′sins (φ′), the coordinates of P, \tilde{P}, P′, \tilde{P}′ are given by

$$P : ( {r}_{1} , {ϕ}_{1} , {z}_{1} ) = ( r , ϕ , z ) ,$$

$$\tilde{P} : ( {r}_{1} , {ϕ}_{1} , {z}_{1} ) = ( r , ϕ + π , z ) ,$$

$${P}^{′} : ( {r}_{1}^{′} , {ϕ}_{1}^{′} , {z}_{1}^{′} ) = ( {r}_{Δ} r , {ϕ}^{′} , z + Δ z ) ,$$

$$\tilde{{P}^{′}} : ( {r}_{2}^{′} , {ϕ}_{2}^{′} , {z}_{2}^{′} ) = ( {r}_{Δ} r , {ϕ}^{′} + π , z - Δ z ) ,$$

$$Δ z = r cos ( ϕ ) sin ( θ ) ,$$

$$Δ r = \sqrt{{sin}^{2} ( ϕ ) + {cos}^{2} ( ϕ ) {cos}^{2} ( θ )} ,$$

$${ϕ}^{′} = arctan ( \frac{tan ( ϕ )}{cos ( θ )} )$$

When an RX antenna is placed at P on the receiver, the signal received at P′ is given by

$$u ( {P}^{′} ) = u ( l , 0 , {r}_{1}^{′} , {ϕ}_{1}^{′} , {z}_{1}^{′} , t ) ≅ u ( l , 0 , r , ϕ , z , t ) {r}_{Δ}^{\vert l \vert} exp ( - il Δϕ ) exp ( - ik Δ z ) .$$

Similarly, for an RX antenna placed at \tilde{P}, the signal received (now at \tilde{P}′) is given

$$\begin{matrix}u ( \tilde{{P}^{′}} ) = u ( l , 0 , {r}_{2}^{′} , {ϕ}_{2}^{′} , {z}_{2}^{′} , t ) ≅ u ( l , 0 , r , ϕ , z , t ) {r}_{Δ}^{\vert l \vert} exp ( - il ( Δϕ + π ) ) exp ( ik Δ z ) \\ = u ( l , 0 , r , ϕ , z , t ) {r}_{Δ}^{\vert l \vert} exp ( - il Δϕ ) exp ( - il π ) exp ( ik Δ z ) \\ = u ( l , 0 , r , ϕ , z , t ) {r}_{Δ}^{\vert l \vert} {( - 1 )}^{l} exp ( - il Δϕ ) exp ( ik Δ z )\end{matrix}$$

Define

$${R}_{1} ( P ) = \frac{{( - 1 )}^{l} u ( P ′ )}{u ( \tilde{P ′} )} = \frac{exp ( - ik Δ z )}{exp ( ik Δ z )} = exp ( - i 2 k Δ z ) , Δ z = \frac{iln ( {R}_{1} ( P ) )}{2 k} ; and {R}_{2} ( P ) = \frac{{( - 1 )}^{l} u ( P ′ ) u ( \tilde{P ′} )}{\vert u ( P ′ ) u ( \tilde{P ′} ) \vert} = exp ( - i 2 l Δ ϕ ) , Δ ϕ = \frac{iln ( {R}_{2} ( P ) )}{2 l} .$$

From Δz=rcos (φ) sin (φ) and

$$Δ ϕ = {ϕ}^{′} - ϕ = arctan ( \frac{tan ( ϕ )}{cos ( θ )} ) - ϕ ,$$

the value (φ, θ) can be computed numerically. Let (φ*, θ*) be the estimated value. Let

$${ϕ}_{1}^{o}$$

be the angle of P₁ with respect to the original y axis,

$${ϕ}_{1}^{o} = {φ}_{D} + ϕ .$$

It follows that

$${φ}_{D}^{*} = {ϕ}_{1}^{o} - {ϕ}^{*} .$$

As a whole, the tilt of the receiver (φ_{D}, θ) is thus derived.

In the above derivation of the tilt of the receiver (φ_{D}, θ), a single pair of RX antennas placed diagonal to each other on the receiver is used.

Because the computation of

$$Δϕ by Δϕ = {ϕ}^{′} - ϕ = arctan ( \frac{tan ( ϕ ) )}{cos ( θ )} ) - ϕ$$

involves arctan ( ) function, which may have very large error in some range, it is hard to estimate Δφ accurately by using one pair of diagonally placed RX antennas. It is better to use multiple (e.g., 2 or more) pairs of diagonally placed RX antennas to derive the tilt of the receiver (φ_{D}, θ).

FIG. 3(a) illustrates two pairs of RX antennas (i.e., four antennas) located at 0°, 90°, 180°, 270° at the rim of the receiver. FIG. 3(b) illustrates 2N pairs of RX antennas located at the rim of the receiver.

Let φ₀ be the angle of P₀ from y′ axis to be estimated; Δz₀=rcos (φ₀) sin (θ) be be estimated from R₁ (P₁), and

$$Δ {z}_{1} = r cos ( {ϕ}_{1} ) sin ( θ ) = r cos ( {ϕ}_{0} + \frac{π}{2} ) sin ( θ ) = - r sin ( {ϕ}_{0} ) sin ( θ )$$

it follows that

$${ϕ}_{0}^{*} = arctan ( \frac{- Δ z ( {P}_{1} )}{Δ z ( {P}_{0} )} ) . {θ}^{*} = arcsin ( \frac{1}{2} ( \frac{- Δ {z}_{0}}{r cos ( {ϕ}_{0}^{*} )} + \frac{- {Δz}_{1}}{r cos ( {ϕ}_{1}^{*} ) )} ) ) .$$

When N (N is three or more) pairs of RX antennas are installed uniformly across the rim of the receiver, their signals can be used jointly to better estimate (φ, θ).

### From

$$Δ {z}_{j} = \frac{iln ( {R}_{1} ( {P}_{j} ) )}{2 k} , \frac{Δ {z}_{N + j}}{Δ {z}_{j}} = \frac{cos ( {ϕ}_{N + j} )}{cos ( {ϕ}_{j} )} = \frac{cos ( {ϕ}_{0} + \frac{j π}{2 N} + \frac{π}{2} )}{cos ( {ϕ}_{0} + \frac{j π}{2 N} )} = - tan ( {ϕ}_{0} + \frac{j π}{2 N} ) ,$$

averaging over

$$j = 0 , … , N - 1 , {ϕ}_{0}^{*} = \frac{1}{N} {\sum }_{j = 0}^{N - 1} ( arctan ( - \frac{Δ {z}_{N + j}}{Δ {z}_{j}} ) - \frac{j π}{2 N} ) = \frac{1}{N} {\sum }_{j = 0}^{N - 1} ( arctan ( - \frac{Δ {z}_{N + j}}{Δ {z}_{j}} ) ) - \frac{π ( {N}^{2} - N )}{4 {N}^{2}} . {θ}^{*} = arcsin ( \frac{1}{N} {\sum }_{j = 0}^{N - 1} \frac{Δ {z}_{j}}{r cos ( {ϕ}_{j}^{*} )} ) .$$

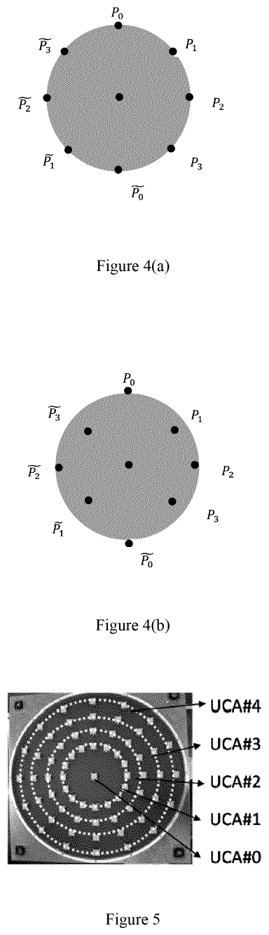

When the pairs of RX antennas are not uniformly placed in a circle (e.g., 0°-360°), the displacement (e.g., tilt) of the receiver can also be estimated. For simplicity, it is assumed that 4 RX antennas (i.e., two pairs of RX antennas) are arranged as a cross with 90° between two adjacent antennas. In addition, Multiple (M) groups of 4 RX antennas (i.e., M groups of two pairs of RX antennas) can be arranged evenly or unevenly across the RX plane. FIG. 4(a) illustrates two groups of 4 RX antennas (i.e., two groups of two pairs of RX antennas) with the same radius; and FIG. 4(b) illustrates two groups of 4 RX antennas (i.e., two groups of two pairs of RX antennas) with different radii, in which each group of 4 RX antennas (i.e., each group of two pairs of RX antennas) has the same radius. The (φ*, θ*) can be estimated by averaging the results derived from these M pairs of (φᵢ, θᵢ), where (φᵢ, θᵢ) is the results obtained from the i^{th} group of 4 RX antennas. Although FIGS. 4(a) and 4(b) illustrate that each group has two pairs of RX antennas, it is possible that each group has different pairs of RX antennas, e.g., one pair of RX antennas, three pairs of RX antennas, etc. In addition, it is also possible that different groups have different pairs of RX antennas.

Based on the above analysis, an auto-alignment of the OAM receiver is proposed.

First, the structure of the receiver is described.

Multiple (N, where N is 2 or more) pairs of RX antennas are arranged on the receiver. Each pair of RX antennas is are placed on opposite sides (i.e., displaced with) 180° with an equal radius from the centre of the receiver in a different angle.

Preferably, all N pairs of RX antennas have the same radius from the centre of the receiver.

Further preferably, N pairs of RX antennas with the same radius from the centre of the receiver are evenly placed, where two adjacent RX antennas are spaced 180°/N apart. It means that all N pairs of RX antennas (i.e., all 2N RX antennas) are evenly placed on a circle with an origin on the centre of the receiver), since all N pairs of RX antennas (i.e., all 2N RX antennas) have the same radius from the centre of the receiver.

The N pairs of RX antennas can be one array of RX antennas in a uniform concentric array (UCA) as shown in FIG. 5, which illustrates an example of UCA type receiver. In the example of FIG. 5, 4 uniform concentric arrays of RX antennas (i.e., UCA #1 to UCA #4) in addition to the center RX antenna (i.e., UCA #θ) are shown, in which each of UCA #1 to UCA #4 can be N pairs of RX antennas. Alternatively, the RX antennas of two or more UCAs (e.g., from UCA #1 to UCA #4) can be N pairs of RX antennas.

As described in above Equation (2), it is assumed that p=0. So, the auto-alignment of the OAM receiver can only be performed when p=0. This disclosure proposes that the auto-alignment of the OAM receiver can be performed when a single mode (l, p) (where l≠0 and p=0) is transmitted from the transmitter (including TX antennas) to the receiver (including RX antennas). In the following description, the single mode (l, p) (where l+0 and p=0) is referred to as mode 0.

OAM transmissions usually multiplex multiple modes together to increase the transmission rate. Since the misalignment estimation can be only performed when only mode 0 is used for transmitting, it is necessary that both the transmitter and the receiver understand a time when only mode 0 is used for transmission. The receiver can use the signal transmitted at this time (when only mode 0 is used) for misalignment estimation.

The signal transmitted using only mode 0 can be referred to as calibration signal.

Because the receiver does not need to know what signal is the calibration signal, the calibration signal can be a well-known signal transmitted from the transmitter, such as a dedicated reference signal, e.g., a single port Channel State Information Reference Signal (CSI-RS) resource, transmitted by only using mode 0, or data stream transmitted during a predetermined time duration (e.g., one or more symbols) by only using mode 0.

Incidentally, the transmitter is not necessary to have the above-described structure of the receiver, e.g., including N pairs of OAM RX antennas, each pair of OAM RX antennas are placed on opposite sides with an equal radius from the centre of the receiver in a different angle, where N is 2 or more. In other words, the transmitter is only necessary to have OAM TX antennas that can transmit a single OAM mode, e.g., mode 0.

The transmitter is necessary to inform the receiver when the calibration signal is transmitted (e.g., by only using mode 0), e.g., by a signaling mechanism. This can be done using radio resource configuration (RRC) (e.g., by a RRC signaling), or lower layer activation method (e.g., by a Media Access Control Control Element (MAC CE) or a Downlink Control Information (DCI)).

For example, a single-port CSI-RS can be defined as the calibration signal, which is to be transmitted by only using mode 0. This CSI-RS can be aperiodic, semi-persistent or periodic, and can be triggered like a traditional CSI-RS. In other words, the triggering of the CSI-RS is the signal to indicate the calibration signal.

When a dedicated reference signal is transmitted as the calibration signal, data transmission is suspended. To avoid suspension of data transmission, regular data transmitted in a predetermined time duration (e.g., one or more symbols) can be used as the calibration signal, for example, by being transmitted by only using mode 0. It means that the data stream can be transmitted without suspension, but is transmitted by only using mode 0. Other modes (l, p) where p=±1, ±2 etc, are suspended in the predetermined time duration (e.g., a particular symbol or particular symbols). This would cause less disruption to data transmission. The particular symbol (or symbols) can be called calibration-data symbol(s). The location of the calibration-data symbol(s) can be configured by RRC signaling. For example, the calibration-data symbol(s) can be activated aperiodically, semi-persistently or periodically using RRC signaling and/or lower layer signal, such as MAC CE or DCI. The signal that activates the calibration-data symbol(s) is the signal to indicate the calibration signal.

Once the RX antennas (e.g., 2 or more pairs of RX antennas) on the receiver receive the calibration signal, the tilt angle (φ_{D}, θ) can be estimated by the apparatus including the receiver, e.g., a processor in the apparatus. A servo system can correct the misalignment of the receiver by making corresponding tilt adjustment in two directions to correct the tilt angle (φ_{D}, θ). The structure of the servo system is out of the scope of this disclosure.

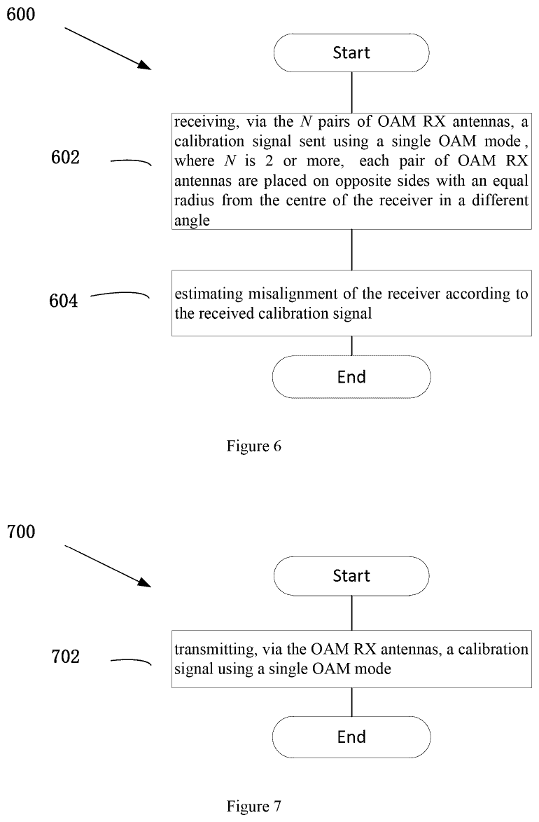

FIG. 6 is a schematic flow chart diagram illustrating an embodiment of a method 600 according to the present application. In some embodiments, the method 600 is performed by an apparatus including a receiver. In certain embodiments, the method 600 may be performed by a processor executing program code, for example, a microcontroller, a microprocessor, a CPU, a GPU, an auxiliary processing unit, a FPGA, or the like.

The method 600 is a method performed at an apparatus including a receiver, where the receiver includes N pairs of OAM RX antennas, each pair of OAM RX antennas are placed on opposite sides with an equal radius from the centre of the receiver in a different angle, where N is 2 or more, the method comprising: 602 receiving, via the N pairs of OAM RX antennas, a calibration signal sent using a single OAM mode; and 604 estimating misalignment of the receiver according to the received calibration signal.

In some embodiment, all N pairs of OAM RX antennas are placed with an equal radius from the centre of the receiver. Preferably, all N pairs of OAM RX antennas are evenly placed.

In some embodiment, the misalignment of the receiver is corrected by a servo system.

In some embodiment, the N pairs of OAM RX antennas form a uniform concentric array.

In some embodiment, the method further comprises receiving a signal indicating the calibration signal. In particular, the signal is a RRC signaling, or a MAC CE, or a DCI.

In some embodiment, the calibration signal is a dedicated reference signal or a data-carrying signal.

In some embodiment, the single OAM mode (l, p) has parameters p=0 and l≠0.

FIG. 7 is a schematic flow chart diagram illustrating an embodiment of a method 700 according to the present application. In some embodiments, the method 700 is performed by an apparatus including a transmitter. In certain embodiments, the method 700 may be performed by a processor executing program code, for example, a microcontroller, a microprocessor, a CPU, a GPU, an auxiliary processing unit, a FPGA, or the like.

The method 700 is a method performed at an apparatus including a transmitter, where the transmitter includes OAM TX antennas, the method comprising: 702 transmitting, via the OAM RX antennas, a calibration signal using a single OAM mode.

In some embodiment, the method further comprises transmitting a signal indicating the calibration signal. In particular, the signal is a RRC signaling, or a MAC CE, or a DCI.

In some embodiment, the calibration signal is a dedicated reference signal or a data-carrying signal.

In some embodiment, the single OAM mode (l, p) has parameters p=0 and l #0.

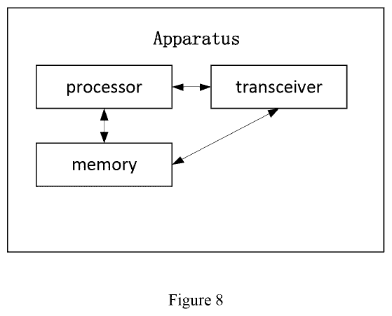

FIG. 8 is a schematic block diagram illustrating an apparatus according to one embodiment.

Referring to FIG. 8, the apparatus includes a processor, a memory, and a transceiver. The transceiver may refer to the OAM antennas (e.g., RX antennas) on the receiver, or the TX antennas on the transmitter. The processor implements a function, a process, and/or a method which are proposed in FIG. 6 or 7.

The apparatus may include a receiver, wherein, the receiver includes N pairs of OAM RX antennas, each pair of OAM RX antennas are placed on opposite sides with an equal radius from the centre of the receiver in a different angle, where N is 2 or more, the apparatus comprises a processor, wherein, the processor is configured to receive, via the N pairs of OAM RX antennas, a calibration signal sent using a single OAM mode; and estimate misalignment of the receiver according to the received calibration signal.

In some embodiment, all N pairs of OAM RX antennas are placed with an equal radius from the centre of the receiver. Preferably, all N pairs of OAM RX antennas are evenly placed.

In some embodiment, the misalignment of the receiver is corrected by a servo system.

In some embodiment, the N pairs of OAM RX antennas form a uniform concentric array.

In some embodiment, the processor is further configured to receive, via the N pairs of OAM RX antennas, a signal indicating the calibration signal. In particular, the signal is a RRC signaling, or a MAC CE, or a DCI.

In some embodiment, the calibration signal is a dedicated reference signal or a data-carrying signal.

In some embodiment, the single OAM mode (l, p) has parameters p=0 and l #0.

The apparatus may include a transmitter, wherein, the transmitter includes OAM TX antennas, the apparatus comprising a processor, wherein the processor is configured to transmit, via the OAM TX antennas, a calibration signal using a single OAM mode.

In some embodiment, the processor is further configured to transmit, via the OAM TX antennas, a signal indicating the calibration signal. In particular, the signal is a RRC signaling, or a MAC CE, or a DCI.

In some embodiment, the calibration signal is a dedicated reference signal or a data-carrying signal.

In some embodiment, the single OAM mode (l, p) has parameters p=0 and l≠0.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. An apparatus for wireless communication, comprising: a receiver, wherein the receiver includes N pairs of orbiter angular momentum (OAM) receiver (RX) antennas, wherein each pair of OAM RX antennas are placed on opposite sides with an equal radius from a center of the receiver in a different angle, and wherein N is 2 or more;
at least one memory; and
at least one processor coupled to the at least one memory and configured to cause the apparatus to:
receive, via the N pairs of OAM RX antennas, a calibration signal sent using a single OAM mode; and
estimate misalignment of the receiver according to the received calibration signal.

2. The apparatus of claim 1, wherein
all N pairs of OAM RX antennas are placed with an equal radius from the center of the receiver.

3. The apparatus of claim 2, wherein
all N pairs of OAM RX antennas are evenly placed.

4. The apparatus of claim 1, wherein
the misalignment of the receiver is corrected by a servo system.

5. The apparatus of claim 1, wherein
the N pairs of OAM RX antennas form a uniform concentric array.

6. The apparatus of claim 1, wherein
the at least one processor is further configured to cause the apparatus to receive, via the OAM RX antennas, a signal indicating the calibration signal.

7. The apparatus of claim 6, wherein the signal is a radio resource control (RRC) signaling, a media access control control element (MAC CE), or a downlink control information (DCI).

8. The apparatus of claim 1, wherein
the calibration signal is a dedicated reference signal or a data-carrying signal.

9. The apparatus of claim 1, wherein the single OAM mode (l, p) has parameters p=0 and l≠0.

10. (canceled)

11. An apparatus for wireless communication, comprising: a transmitter, wherein the transmitter includes orbiter angular momentum (OAM) transmitter (TX) antennas;
at least one memory; and
at least one processor coupled with the at least one memory and configured to cause the apparatus to:
transmit, via the OAM TX antennas, a calibration signal using a single OAM mode.

12. The apparatus of claim 11, wherein
the at least one processor is further configured to cause the apparatus to transmit, via the OAM TX antennas, a signal indicating the calibration signal.

13. The apparatus of claim 12, wherein the signal is a radio resource control (RRC) signaling, a media access control control element (MAC CE), or a downlink control information (DCI).

14. The apparatus of claim 11, wherein
the calibration signal is a dedicated reference signal or a data-carrying signal.

15. The apparatus of claim 11, wherein the single OAM mode (I, p) has parameters p=0 and l≠0.

16. A method performed by an apparatus including a receiver, wherein the receiver includes N pairs of orbiter angular momentum (OAM) receiver (RX) antennas, wherein each pair of OAM RX antennas are placed on opposite sides with an equal radius from a center of the receiver in a different angle, and wherein Nis 2 or more, the method comprising:
receiving, via the N pairs of OAM RX antennas, a calibration signal sent using a single OAM mode; and
estimating misalignment of the receiver according to the received calibration signal.

17. The method of claim 16, further comprising:
receiving, via the OAM RX antennas, a signal indicating the calibration signal.

18. The method of claim 17, wherein the signal is a radio resource control (RRC) signaling, a media access control control element (MAC CE), or a downlink control information (DCI).

19. The method of claim 16, wherein the calibration signal is a dedicated reference signal or a data-carrying signal.

20. The method of claim 16, wherein the single OAM mode (1, p) has parameters p=0 and l≠0.

21. A method performed by an apparatus for wireless communication, wherein the apparatus includes a transmitter having orbiter angular momentum (OAM) transmitter (TX) antennas, the method comprising:
transmitting, via the OAM TX antennas, a calibration signal using a single OAM mode.
